(19) United States
(12) Patent Application Publication
(10) Pub. No.: US 2008/0257806 A1
(43) Pub. Date: Oct. 23, 2008

(54) Method and Apparatus for Treating Wastes, Particularly of a Biological and Domestic Origin

(76) Inventor: Silvano Rossato, Selavazzano Dentro (IT)

Correspondence Address: K.F. ROSS P.C., 5683 RIVERDALE AVENUE, SUITE 203 BOX 900, BRONX, NY, 10471-0900, US

(21) Appl. No.: 12/067,475

(22) PCT Filed: Sep. 11, 2006
(86) PCT No.: PCT/IB06/02489

§ 371 Date: Mar. 20, 2008

(30) Foreign Application Priority Data
Sep. 15, 2005 (IT) PD2005A000265

(51) Int. Cl. B01D 1/14

(52) U.S. Cl. 210/173; 34/60

(57) ABSTRACT

Method and apparatus (3) for treating wastes, particularly of a biological and domestic origin, whose peculiarity consists in the fact of comprising a first treating step and first means (4) for treating such wastes for the purpose of separating a liquid fraction essentially suitable for disposal and a semisolid fraction for further processing, and a second treating step and second means (5) for treating the semisolid fraction separated in such first treating step and by such first treating means for the purpose of eliminating the residual moisture contained in such semisolid fraction, so as to turn such semisolid fraction into a block of dry refuse suitable for handing over to the municipal solid refuse collecting and disposal services.

The object of the present invention is a method and an apparatus for treating wastes, particularly of a biological and domestic origin, especially for application in campers, caravans, tourist buses and boats.

The mentioned facilities are known to be fitted with elementary treating equipment for the biological and domestic wastes produced during the use of these facilities. The disposal of these wastes consequently occurs according to very particular procedures and ways. As regards the equipment, said means are only equipped with a first and a second tank of suitable volume, appropriately connected to the utilities onboard the facility, so as to collect the biological wastes in the first tank and the domestic wastes in the second tank. The procedures and ways of disposing of such wastes are in turn involving the periodical voiding of such tanks, at the care of the facilities' users, in appropriate tanks normally provided in parking or staying areas for campers, caravans, and tourist buses or in port areas for boats.

The principal drawback recognized in this mode of managing biological and domestic wastes consists in that said areas are sparsely distributed over the territory and even lacking in certain countries. This fact compels the users of these facilities to condition their holiday itineraries to the localization of such areas, and most often to drive for long stretches to reach them, thus aggravating fuel consumption and curtailing vacationing time. In order to avoid taking such journeys, the wastes are often left beside the roads, thus causing an obvious environmental damage. This behaviour appears to prevail even among boat users which, if at open sea, void their tanks directly into the sea, thus also causing serious environmental damage.

The German patent application No. DE3333481 A1 describes a process and an apparatus for the disposal of biological wastes for vehicles, preferably caravans, campers etc. According to this process, the solid fraction is separated from the liquid fraction, said solid fraction is in turn dried and subsequently stored in a container awaiting disposal. The apparatus for realizing this process essentially comprises means for collecting said wastes, filtering and centrifuging means housed inside said collecting means to filter and centrifuge said wastes so as to separate said wastes in a solid and a liquid phase, evacuating means connected with said collecting means to evacuate said liquid fraction, drying means connected with said collecting means to dry said solid fraction, removing means acting on said filtering/centrifuging means to remove said solid fraction, and finally, storing means connected with said centrifuging means to store said solid fraction.

The main drawback found in such apparatus consists in the fact that the filtering/centrifuging means tend to plug up very easily. Once dried, the solid fraction in fact obstructs the filtering/centrifuging means and removing means are unable to unplug them. The apparatus consequently appears unsuitable for cyclic use over relatively prolonged time periods.

A second drawback found in such apparatus consists in the fact that the drying means are unsuitable for achieving an adequate drying of the solid fraction. These drying means are in fact lacking an evacuating duct to evacuate the drying gases along with the water vapour removed from the solid fraction, the solid fraction thus tends to remain moist. Said solid fraction consequently appears unsuitable for the subsequent storing and manipulating operations.

A third drawback recognizable in such apparatus consists in that it lacks treating means for treating the drying gases, the water vapour and the malodorous volatile substances released by wastes under treatment, so as to render them suitable for discharging to the atmosphere. The apparatus consequently appears unsuitable for its intended application.

The European patent application No. EP 0368 350 describes another apparatus for the disposal of biological wastes for vehicles with endothermic engines. This apparatus essentially comprises collecting means to collect the wastes, circulating means connected to said collecting means to circulate said wastes, pumping/dosing means connected to said circulating means to pump/dose said wastes, preheating means connected to said pumping/dosing means and to liquid engine cooling means to preheat said wastes, compacting means connected to said preheating means to compact the solid fraction contained in said wastes, drying means connected to said compacting means and to the waste gas discharging means from said vehicle to dry said solid fraction, storing means connected to said compacting means to store said solid fraction, and finally, first conveying means connected to said storing means and to the engine aspirating means to convey the recovered gaseous fraction to said engine for its combustion, and second conveying means connected to said storing means and to said collecting means to convey the liquid fraction recovered in said apparatus.

The main drawback recognized in this apparatus consists in that the operation of this apparatus determines a progressive increase of the liquid fraction in the wastes to be treated. The compacting means provided for this purpose in fact operates under conditions suitable for wastes in a dense condition. This condition is achieved by the pumping/dosing means that introduce wastes in this condition into the preheating means, and return most of the liquid fraction to the circulating means. Consequently, during the operation of the apparatus only a minor portion of the wastes is subjected to treatment, while the greater portion is accumulated awaiting treatment. This problem obviously determines serious managing problems of the apparatus.

The principal aim of this invention is to achieve a method and an apparatus for treating wastes, particularly of a biological and domestic origin, capable of eliminating the mentioned problems.

Within the limits of the main task stated above, an important object of the present invention is to set up a method and an apparatus to allow treating such wastes so as to make them suitable partly for a direct discharge to the ground and into the air, and partly for a disposal by the municipal solid refuse collecting and disposing services.

Another important object of the present invention is to set up an apparatus equipped with means for separating the solid from the liquid fraction of the wastes, suitable for disposing among urban solid wastes.

A further important object of the present invention is to set up an apparatus wherein said separating means performs a solid fraction filtration and retention function, so as to allow its disposal along with said solid fraction.

A further important object of this invention is to set up a method and an apparatus capable to allow treating such wastes without using chemical additives and mechanical means to be set in motion for treating the solid fraction.

Not the last object of this invention is to set up an apparatus particularly suitable for an application in campers, caravans, tourist buses and boats, and as an alternative to the known disposal systems.

This aim, as well as these objects and others, that will be better apparent in the following, are achieved by a method and an apparatus for treating wastes, particularly of a biological and domestic origin according to the attached claims.

In accordance with advantageous first characteristics of the invention, the method essentially consists of the following steps:

a first step of treating the waste for the purpose of separating a liquid fraction essentially suitable for disposal and a semisolid fraction to be further processed;

a second step of treating the semisolid fraction for the purpose of separating in the first treating phase in order to eliminate the residual moisture contained in the semisolid fraction.

In turn, the apparatus comprises first means for treating the waste for the purpose of separating a liquid fraction suitable for disposal and a semisolid fraction to be further processed, and second means for treating the semisolid fraction separated by the first treating means for the purpose of eliminating the residual moisture contained in the semisolid fraction.

The semisolid fraction is thus reduced to a solid block of refuse, suitable for handing over to the solid municipal refuse collecting and disposal services.

In accordance with second advantageous characteristics of the invention, the mentioned first and second treating steps simply consist in a multiple number of waste filtration steps and in a semisolid fraction drying step.

In turn, the mentioned first and second treating means of the apparatus are achieved by a filtration mean comprising a multistage filter element and a source of heat generating a gaseous drying stream, and by conveying means embracing said filter element, that convey the gaseous drying stream so as to strike the multistage filter element wherein the semisolid phase is collected. This multistage filter element is appropriately realized in a biodegradable or similar material, so as to form, the above mentioned dry refuse block, together with the semisolid fraction.

In accordance with other advantageous characteristics of the invention, the heat source in the apparatus is formed by the endothermic engine of the device, the gaseous drying stream is formed by the engine's exhaust gases, and the conveying means are formed by engine's exhaust pipe.

Further characteristics and advantages of the invention will be more clearly evident from the description of the method for treating wastes, particularly of a biological and domestic origin, and of an embodiment of the apparatus that implements this method, as illustrated for exemplifying but not limiting purposes in the two enclosed drawings, wherein:

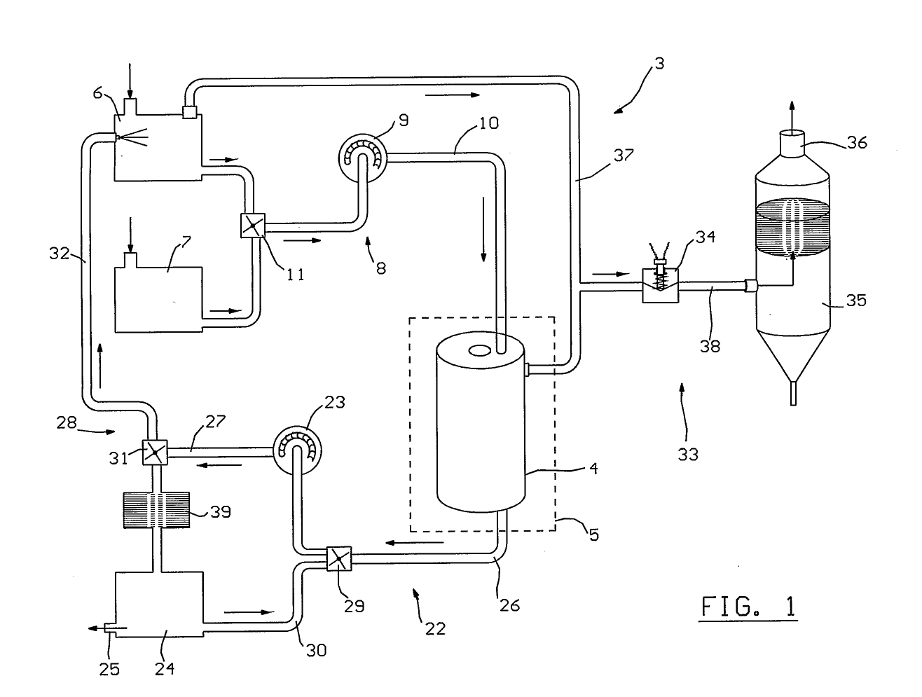

FIG. 1 represents an overall view of the apparatus, according to the invention, in a first executive form;

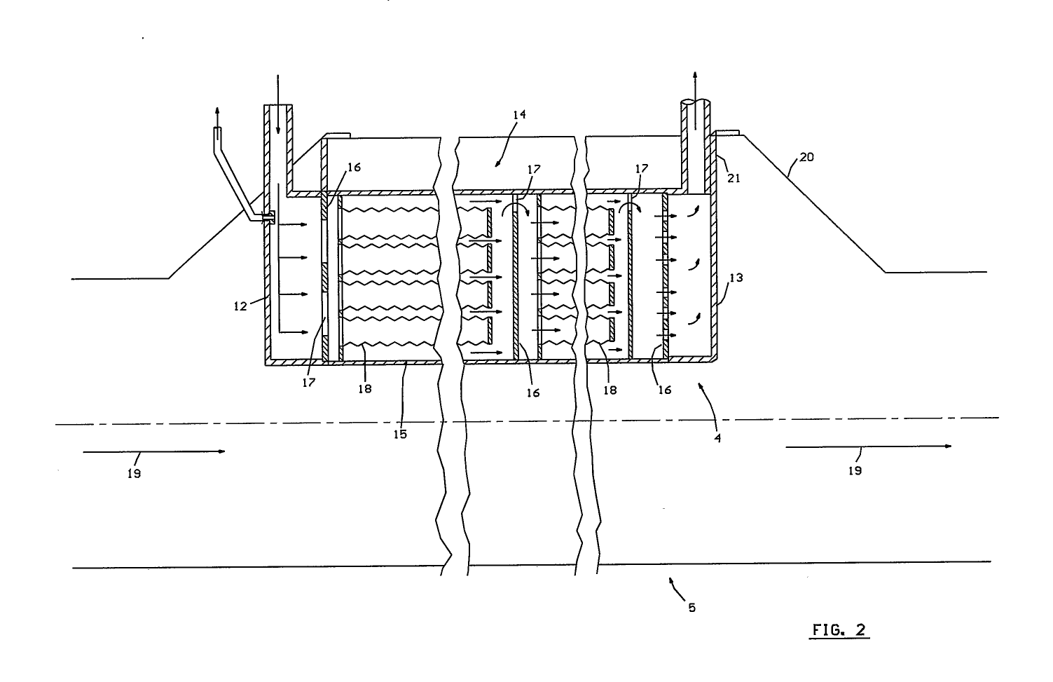

FIG. 2 represents a detailed view, partially sectionalized along an axial plane, of the first and second treating means incorporated into the apparatus of FIG. 1.

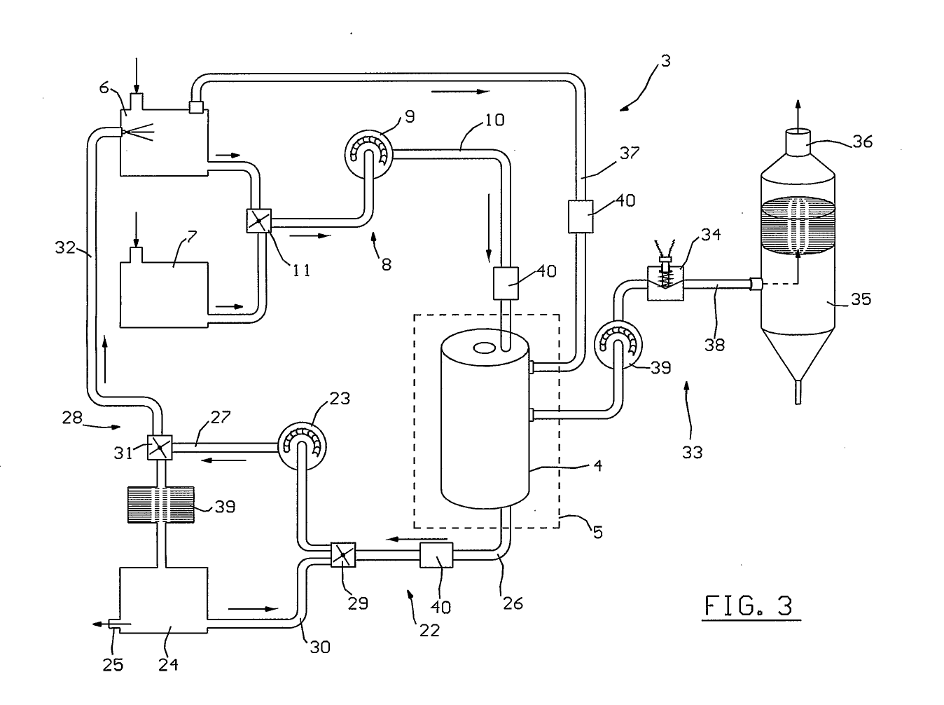

FIG. 3 represents an overall view of the apparatus according to the invention, in a second executive form.

The method for treating wastes, particularly of biological and domestic origin according to the invention, consists essentially of the following steps: a first step of treating the waste for the purpose of separating a liquid fraction essentially suitable for disposal and a semisolid fraction to be further processed; a second step of treating the semisolid fraction separated in the first treating phase for the purpose of eliminating the residual moisture contained in the semisolid fraction. The semisolid fraction is thus reduced to a dry block of refuse suitable for handing over to the municipal solid refuse collecting and disposal services, in a single block with the filtering medium itself. In greater detail, the first treating step consists in a multiple number of waste filtration steps and the second treating step consists in a semisolid fraction drying step. This latter drying step is appropriately carried out at a temperature suitable for converting the bacterial charge contained in the semisolid fraction to an inert mass. The suitable temperature has been identified to be approximately in the range between 110° C. and 120° C. The method also comprises a step for purifying the residual moisture in the form of steam, so as to make it suitable for an odourless discharge to the open air.

With particular reference to the mentioned figures, the apparatus for treating wastes, particularly of a biological and domestic origin, indicated as a whole by the reference number 3, comprises, above all, first means for treating the waste 4 for the purpose of separating a liquid phase suitable for disposal and a semisolid fraction for further processing, and subsequently second means 5 for treating the semisolid fraction separated by the first treating means 4 for the purpose of eliminating the residual moisture contained in the semisolid fraction. In detail, the apparatus 3 appropriately comprises first collecting means 6 to collect the wastes of a biological origin (urine and feces) and second collecting means 7 to collect the wastes of a domestic origin (wash water etc.) The apparatus 3 further comprises feeding means 8 to feed the first treating means 4 together with the wastes originating from the first and second collecting means 6, 7. In detail, these feeding means 8 comprise a pumping/macerating device 9, feeding means to connect the collecting means 6, 7 to the inlet of the pumping/macerating device 9 and a discharge pipe 10 connecting the outlet of the pumping/macerating device 9 to the first treating means 4. In particular, the feeding means are in turn comprising first selective valve switching means that selectively connect the pumping/macerating device 9 to the first collecting means or to the second collecting means 7. The first treating means 4 in turn comprise at least one filtering means that receives the wastes at its inlet through the discharge pipe 10 and returns a liquid fraction suitable for disposal at its outlet. In particular, said filtering means comprises a waste inlet manifold 12 connected to the discharge pipe 10, a liquid fraction outlet manifold 13 connected to a discharge and a multistage filtration element 14 interposed between the inlet manifold 12 and the outlet manifold 13, wherein the semisolid fraction is collected. The multistage filtration element 14 in turn comprises a holding body 15 that defines a cylindrical cavity, a series of separating partitions 16 arranged internally and transversally in the cavity that define a multiple number of filtration chambers arranged in sequence, a multiple number of openings 17 provided in said separating walls 16 so as to render the filtration chambers inter-communicating, and a multiple number of blind sleeves 18 made of a porous material and longitudinally inserted into the chambers with their openings turned toward the waste inlet areas to these chambers, which are progressively increasing their porosity while passing from one filter stage to the next. Sealing gaskets (not shown) are appropriately placed opposite the contact areas of the multistage filtration element 14 with the inlet manifolds 12 and the outlet manifolds 13.

The multistage filtration element 14 is advantageously made of a biodegradable material, so as to form the mentioned block of dry refuse, together with the dry semisolid fraction. The second treating means 5 are in turn realized from a heat source (not shown), which generates a gaseous drying stream (indicated by the arrows 19 in FIG. 2) and from conveying means 20 that embrace the multistage filtration element 14, so as to convey the gaseous drying stream 19 to strike the multistage filtration element 14. In the case of the preferred embodiment of the apparatus 3 shown here, the source of heat consists of an endothermic engine (not shown), such as for instance of a camper. The gaseous drying stream consists of the exhaust gases generated by the engine, and the conveying means 20 are formed by the engine's exhaust pipe. According to an alternative embodiment not shown here, the thermal source comprises an electric fan that generates a gaseous stream, and drying means of a heat resistance, liquified petroleum gas or gas oil burner type that heat the gaseous phase. The conveying means 20 appropriately comprise an opening, normally closed by a door 21, that allows the user to access the interior of said conveying means 20 for the purpose of carrying out the operation of removing the block and of installing a new multistage filtration element 14. The apparatus 3 further comprises liquid fraction evacuating means 22 connected to the outlet manifold 13 of the multistage filtration mean 14. In detail, these evacuating means 22 comprise a pumping device 23, and an accumulating tank 24 designed to accumulate the liquid fraction, provided with an inlet and a discharge valve 25 that is normally closed, a suction pipe 26 that connects the outlet manifold 13 of the multistage filtration mean 14 with the inlet of the pumping device 23, and a transfer pipe 27 that connects the outlet of the pumping device 23 with the tank inlet 24.

Moreover, the apparatus 3 comprises washing means 28 for the first collecting means 6 and for the pumping/macerating device 9. Particular, said washing means 28 comprise second selective valve switching means 29 arranged along the suction pipe 26 upstream of the pumping device 23, a first pipe 30 that connects the tank 24 to the final branch of the suction pipe 26 through the second selective valve switching means 29, third selective valve switching means 31 arranged along the transfer pipe 27 downstream of the pumping device 23, and finally a second pipe 32 that connects the initial branch of the transfer pipe 27 to the first collecting means 6 by using the third selective valve switching means 31. Finally, the apparatus 3 comprises means 33 for purifying residual moisture in the form of steam, so to make it suitable for discharging to the open air. In detail, the purifying means 33 comprise an aspirator 34 for aspirating the vapours, an activated carbon filtration device to purify the moisture equipped with a discharge chimney 36 to release the purified water vapour to the open air, a first connecting pipe 37 that connects the first collecting means 6 and the first treating means 4 to the aspirator inlet 34, and a second connecting pipe 38 that connects the aspirator outlet 34 to the inlet of the activated carbon filtration device 36. In summary, the apparatus 3 is equipped with a programmable microprocessor (not shown) that performs the task of controlling the operative sequences of the apparatus 3. The apparatus 3 may comprise a further activated carbon or ultraviolet ray filtration device arranged along the final branch of the transfer pipe 27, which is included between the third selective switching valves 31 and the tank 24, for the purpose of purifying and sterilizing the liquid portion. In the second executive form of the apparatus 3 shown in FIG. 3, the treating means 4 are of a leak-proof type. These are connected with the purifying means 33 through a pumping device 39. The latter performs the function of producing a vacuum condition inside the first treating means 4, so as to considerably ease the evaporation of the liquid fraction. The branches of the pipes 10, 37 and the branches of the pipes 26 which are leading to/departing from the first treating means 4 are fitted with check valves 40, so as to isolate the first treating means 4 from the rest of the apparatus 3 during the operating phase of the pumping device 39.

With reference to the mentioned figures, the operation of the apparatus 3 is as follows. It is assumed that the first and the second collecting means 6, 7 are respectively full of biological and domestic wastes. The microcontroller prepares the apparatus 3 to perform the operation of treating the domestic wastes. The apparatus 3 is set up as follows: the second collecting means 7 are connected to the pumping/macerating device 9 using the first selective valve switching means 11 and the first filtration means 4 are connected to the tank 24 using the second and third selective valve switching means 29, 31 and the pumping device 23. In this operation, the wastes contained in the collecting means 7 are aspirated by the pumping/macerating device 9, sent to the first treating means 4 where they are subjected to a severe filtration and are then pushed through the unit 39 which takes care of a sterilization and an even finer filtration through activated carbon and/or ceramic filters in a stationary plant, prior to being discharged to the tank 24. At the conclusion of this operation, the microcontroller prepares the apparatus 3 to perform the operation of treating the biological wastes.

The new set-up of the apparatus 3 involves connecting the collecting means 6 to the pumping/macerating devices 9, through the first selective valve switching means 11. In this operation, the wastes contained in the collecting means 6 are aspirated and macerated by the pumping/macerating device 9, which sends them to the first treating means 4 where the first treating step described above takes place, so as to separate the wastes into a liquid fraction that is discharged to the tank 24, and into a semisolid fraction that collects in the multistage filtration element 14. After concluding this operation, the microcontroller prepares the apparatus 3 to perform the washing operation of the first collecting means 6 and of the pumping/macerating device 9. The new set up of the apparatus 3 involves placing the tank 24 in contact with the first collecting means 6 through the washing means 28. In this case, the pumping device 23 picks up part of the liquid fraction contained in the tank 24 and transfers it to the first collecting means 6, from where it is aspirated by the pumping/macerating device 9 that transfers it to the first treating means 4, where it undergoes the first treating phase described above. After concluding this operation, the microcontroller prepares the apparatus 3 to perform the operation of drying the multistage filtration element 14. This operation is performed when the engine is running, for instance when the vehicle is moving. In this manner the exhaust gases are progressively drying the multistage filtration element 14 and the semisolid fraction contained in the same, until these are dried to a block of dry refuse. The residual moisture evolving in the form of steam during this operation is aspirated and purified by the purifying means 33 and then discharged to the open air. Once this operation is concluded, the user will proceed to discharge the tank 24 and to remove the block of dry refuse, so as to substitute it with a new multistage filtration element 14. The apparatus 3 is thus set up for a new cycle.

It has in practice been found that the method and the apparatus thus described achieve their expected task and scopes.

The method and apparatus according to the invention are susceptible of numerous modifications and variants, all falling within the range of the same inventive concept.

In the practical embodiment, the materials used, the shapes, dimensions and executive details may differ from those indicated above but be technically equivalent to them, without thereby abandoning the scope of the invention.

1-29. (canceled)

30. An apparatus for treating wastes, particularly of a biological and domestic origin, comprising:
first means for treating the wastes for the purpose of separating a liquid fraction suitable for disposal and a semisolid fraction for further processing, and
second means for treating the semisolid fraction separated by the first treating means for the purpose of eliminating the residual moisture contained in the semisolid fraction so as to turn the semisolid fraction into a block of dry refuse suitable for handing over to the municipal solid refuse collecting and disposal services, wherein the first means for treating comprise at least one filtration device that receives the wastes at its inlet and returns the liquid fraction at its outlet in the form suitable for disposal, the at least one filtration device comprising a multistage filtration element wherein the semisolid fraction collects, the multistage filtration element being made of a biodegradable material so that the multistage filtration element forms the block of dry refuse together with the semisolid dry fraction.

31. The apparatus according to claim 30, comprising feeding means to feed the first treating means together with the wastes originating from the first and second collecting means.

32. The apparatus according to claim 31, wherein the feeding means comprise a pumping/macerating device, feeding pipes that connect the collecting means to the inlet of the pumping/macerating device and a discharge pipe that connects the outlet of the pumping/macerating device to the first treating means.

33. The apparatus according to claim 30, wherein the multistage filtration element comprises a holding body that defines a cylindrical cavity, a series of separating walls arranged internally and transversely in the cavity that define a multiple number of filtration chambers arranged in succession, a multiple number of openings made in the separating walls so as to render the filtration chambers intercommunicating, and a multiple number of blind sleeves made of a porous material and longitudinally inserted in the chambers with their openings turned toward the inlet areas of the wastes into the chambers.

34. The apparatus according to claim 30, wherein the second treating means comprise a heat source that generates a gaseous drying stream and conveying means that embrace the multistage filtration element and convey the gaseous drying stream to strike the multistage filtration element.

35. The apparatus according to claim 34, wherein the heat source is constituted by an endothermic engine, the gaseous drying stream is constituted of the exhaust gases of the engine, and the conveying means are formed by the engine's exhaust pipe.

36. The apparatus according to claim 34, wherein the heat source comprises an electrical fan which generates the gaseous stream, and drying means of an electrical resistance or liquified petroleum gas and gas oil burner type which heat the gaseous stream.

37. The apparatus according to claim 30, further comprising means for evacuating the liquid fraction, that are connected to the filtration device.

38. The apparatus according to claim 37, wherein the evacuating means comprise a pumping device, an accumulating tank for accumulating the liquid fraction equipped with an inlet and a normally closed discharge valve, a suction pipe which connects the multistage filtration device to the inlet of the pumping device, and a transfer pipe that connects the outlet of the pumping device to the inlet of the tank.

39. The apparatus according to claim 30, further comprising washing means for the first collecting means and for the pumping/macerating device.

40. The apparatus according to claim 39, wherein the washing means comprise second selective valve switching means arranged along the suction pipe upstream of the pumping device, a first pipe that connects the tank to the final branch of the suction pipe through the second selective valve switching means, third selective valve switching means arranged along the transfer pipe downstream of the pumping device and a second pipe that connects the initial branch of the transfer pipe to the first collecting means, through the third selective valve switching means.

41. The apparatus according to claim 30, further comprising means for purifying the residual moisture in the form of steam, to make it suitable for discharging to the open air.

42. The apparatus according to claim 41, wherein the purifying means comprise an aspirator for aspirating vapours, an activated carbon filtration device for purifying the moisture and a discharge chimney to release the purified vapour to the open air, a first connecting pipe that connects the first collecting means and the first treating means to the inlet of the aspirator, and a second connecting pipe that connects the outlet of the aspirator to the inlet of the activated carbon filtration device.

43. The apparatus according to claim 30, further comprising an appropriately programmed microcontroller to control the operating sequences of the apparatus.

44. The apparatus according to claim 30, further comprising an additional activated carbon or ultraviolet radiation filtration device arranged along the final branch of the transfer pipe, which included between the third selective valve switching means and the tank.

45. The apparatus according to claim 30, further comprising a pumping device arranged between the first treating means and the purifying means for the purpose of creating a vacuum in the first treating means, so as to facilitate the evaporation of the liquid fraction.
